(19) United States
(12) Patent Application Publication
(10) Pub. No.: US 2025/0075728 A1
(43) Pub. Date: Mar. 6, 2025

(54) METHODS FOR INSTALLING A NON-CONVENTIONAL FASTENER

(71) Applicant: Sunrun Inc., San Francisco, CA (US)

(72) Inventors: Martin John Affentranger, JR., Paso Robles, CA (US); Michael Kevin Watkins, Oceano, CA (US); Barry Stuart Huseby, Nevada City, CA (US)

(21) Appl. No.: 18/242,287

(22) Filed: Sep. 5, 2023

(51) Int. Cl. F16B 25/00

(52) U.S. Cl. CPC F16B 25/0073; F16B 25/0047; F16B 25/0063; F16B 25/0015

(57) ABSTRACT

Fasteners along with systems and methods employing such fasteners for use of securing a surface component to an underlying wooden structure are disclosed. In some embodiments, a fastener has a minor diameter that is variable between proximal and distal ends of a shaft and a major diameter that is constant between the proximal and distal ends. In some embodiments, a fastener has a major diameter that is variable between the proximal and distal ends. In some embodiments, thread depth of the unconventional fastener having a greater thread depth than similarly-sized fasteners is disclosed. In some embodiments, a fastener has a thread pitch that is greater than a thread pitch of a similarly-sized published fastener.

### TECHNICAL FIELD

The present invention relates to solar panel systems, and in particular, to mounting assemblies installed to installatoin surface of a solar panel system.

### BACKGROUND

Building-mounted structures are typically secured to a building surface with one or more solar power mounting assemblies. Each assembly may include multiple components which, when coupled together, facilitate the ability to mount solar components above an installation surface to which solar panel modules may be mounted during the installation of systems designed to generate solar power. An example of multiple components is disclosed by McPheeters et al. in U.S. Pat. No. 10,090,800 entitled “Solar Panel Installation System and Methods” issued on Oct. 2, 2018, a publication which is incorporated by reference herein in its entirety.

When mounts are coupled to an installation surface, multiple fasteners may be employed to couple one mount. When multiple mounts are used to mount multiple components, the amount of time and man-power necessary are not insignificant. To provide a more efficient installation process, tracks have been developed for which only one fastener is needed to secure the track to an installation surface. An example of such track is disclosed by McPheeters et al. in U.S. Pat. No. 10,205,419 entitled “Railless Solar Module Installation Systems and Devices” issued on Feb. 12, 2019, a publication which is incorporated by reference herein in its entirety.

Mounts have also been developed for which only one fastener is needed to secure the mount to an installation surface. An example of such mount is disclosed by Affentranger, Jr. in U.S. Pat. No. 11,695,369 entitled “Surface Mount Assemblies for a Solar Panel System” issued on Jul. 4, 2023 (Affentranger), a publication which is hereby incorporated by reference herein in its entirety.

Fasteners have also been developed for securing tracks and mounts of solar power mounting assemblies to installation surfaces. An example of one fastener securing a mount is disclosed by McPheeters et al. in U.S. Pat. No. 10,890,205 entitled “Watertight Fastening Devices Employed in a Solar Panel Installation System” issued on Jan. 12, 2021, a publication which is incorporated by reference herein in its entirety.

Conventional fasteners are ubiquitously employed. Typically, these fasteners may have been manufactured to standards developed by standard settings organizations. One such organization is American Society of Mechanical Engineers (ASME) which publishes a portfolio of standards including, but not limited to pressure technology, power plants, elevators, construction equipment, piping, and nuclear components. Standards for lag screws, concrete anchors, concrete screws, lag screws, metal screws, and wood screws as discussed in Affentranger have standards published by ASME.

While published standards provide a commonality of understanding between manufacturers, buyers, and sellers, the installation speed at which conventional fasteners may be set into place and tightened to the desired torque are limited to the published designs of such fasteners.

### SUMMARY

Embodiments of the inventive concepts disclosed herein are directed to systems, fasteners, and methods that may be employed for securing a surface component such as, but not limited to, a surface mount. to a wooden installation surface. When employed, the amount of time needed to secure the surface mount to the installation surface may be reduced, thereby providing a more efficient installation of a mounted structure or assembly to which the surface mount, where the surface mount and surface mount enclosure may facilitate a solar module frame of a solar module or an array of solar modules to be suspended above the installation surface that which the structure.

In some embodiments, only one fastener may be needed to secure the surface mount to the installation surface and only one fastener needed to mount a surface mount enclosure. In some embodiments, a user may position a surface mount above a surface of installation with a fastener(s) positioned within apertures of the mount so that a tip(s) of the fastener(s) extends within the aperture and beyond a bottom surface of the mount. Here, a user may begin to apply a tightening force to the fastener(s) while the tip(s) are in contact but the mount is not; rather, the mount positioned is above the surface as the tightening force is applied.

In one aspect, embodiments of the inventive concepts disclosed herein are directed to a fastener with a minor diameter of a shaft that is variable between the proximal and distal ends of a threaded portion, and a major diameter of a thread that is constant between the proximal and distal ends.

In a further aspect, embodiments of the inventive concepts disclosed herein are directed to a fastener with a minor diameter of the shaft that is variable between the proximal and distal ends of a threaded portion, and a major diameter of the thread that is variable between the proximal and distal ends.

In a further aspect, embodiments of the inventive concepts disclosed herein are directed to a function of differences between thread depths of an unconventional fastener having one major diameter at a proximal end of a threaded portion and published fasteners having major diameters that are less than or equal to the major diameter of the unconventional fastener.

In a further aspect, embodiments of the inventive concepts disclosed herein are directed to a function of differences between thread depths of an unconventional fastener having one major diameter at a distal end of a threaded portion and published fasteners having major diameters that are less than or equal to the major diameter of the unconventional fastener.

In a further aspect, embodiments of the inventive concepts disclosed herein are directed to a fastener with a thread pitch that is greater than a thread pitch of a similarly-sized published fastener.

### BRIEF DESCRIPTION OF THE DRAWINGS

For a fuller understanding of the inventive embodiments, reference is made to the following description taken in connection with the accompanying drawings in which:

FIGS. 1A through 1D, inclusive, present conventional standards of a conventional wood screws and lag screws as published in ASME B18.6.1, in accordance with some embodiments;

FIGS. 2A through 2C, inclusive, present conventional standards of a conventional wood screws and lag screws as published in ASME B18.2.1, in accordance with some embodiments;

FIGS. 3A through 3E, inclusive, illustrate an unconventional lag screw that is non-conformal to the standards set forth in ASME B18.2.1 and ASME B18.6.1, in accordance with some embodiments;

FIGS. 4A through 4C, inclusive, illustrate the unconventional lag screw except with a variable major diameter, in accordance with some embodiments

FIGS. 5A through 5D, inclusive, illustrate the unconventional lag screw except with a variable major diameter and a constant minor diameter, in accordance with some embodiments;

FIGS. 6A through 6C, inclusive, illustrate the unconventional lag screw except with a variable major diameter and an addition of two threads, in accordance with some embodiments; and

FIGS. 7A through 7C, inclusive, illustrate the unconventional lag screw except with a variable major diameter and a variable thread pitch, in accordance with some embodiments.

### DETAILED DESCRIPTION

In the following description, several specific details are presented to provide a thorough understanding of embodiments of the inventive concepts disclosed herein. One skilled in the relevant art will recognize, however, that the inventive concepts disclosed herein can be practiced without one or more of the specific details or in combination with other components. In other instances, well-known implementations or operations are not shown or described in detail to avoid obscuring aspects of various embodiments of the inventive concepts disclosed herein.

Conventional fasteners are manufactured in accordance with standard specifications published by the American Society of Mechanical Engineers (ASME). Conventional fasteners such as wood screws and lag screws that could be employed during the installation of solar components to installation surfaces may be manufactured to sizes, dimensions, and tolerances published in ASME B18.6.1 entitled “Wood Screws (Inch Series)” and ASME B18.2.1 entitled “Square, Hex, Heavy Hex, and Askew Head Bolts and Hex, Heavy Hex, Hex Flange, Lobed Head, and Lag Screws (Inch Series)”, publications which are incorporated by reference herein in their entirety. For the sole purpose of illustration and not of limitation, the following discussion will be drawn to fasteners manufactured in accordance with standards ASME B18.6.1 and ASME B18.2.1 that may be employed when solar power mounting components and/or assemblies are secured to installation surfaces. The embodiments disclosed herein apply to any threaded fastener that could be manufactured in accordance with the disclosures presented herein.

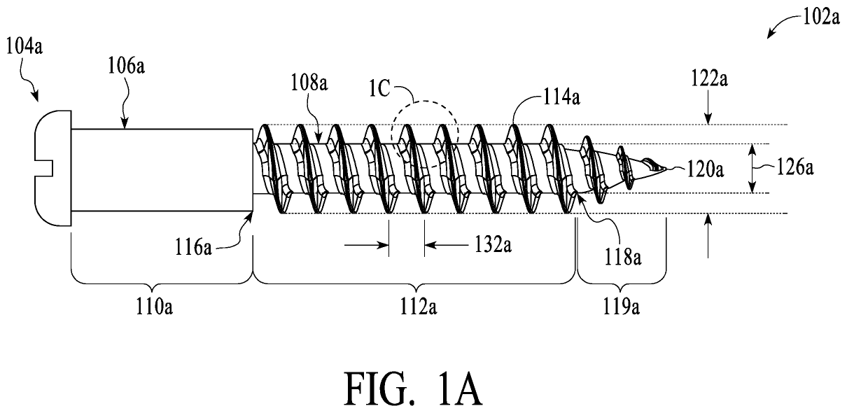

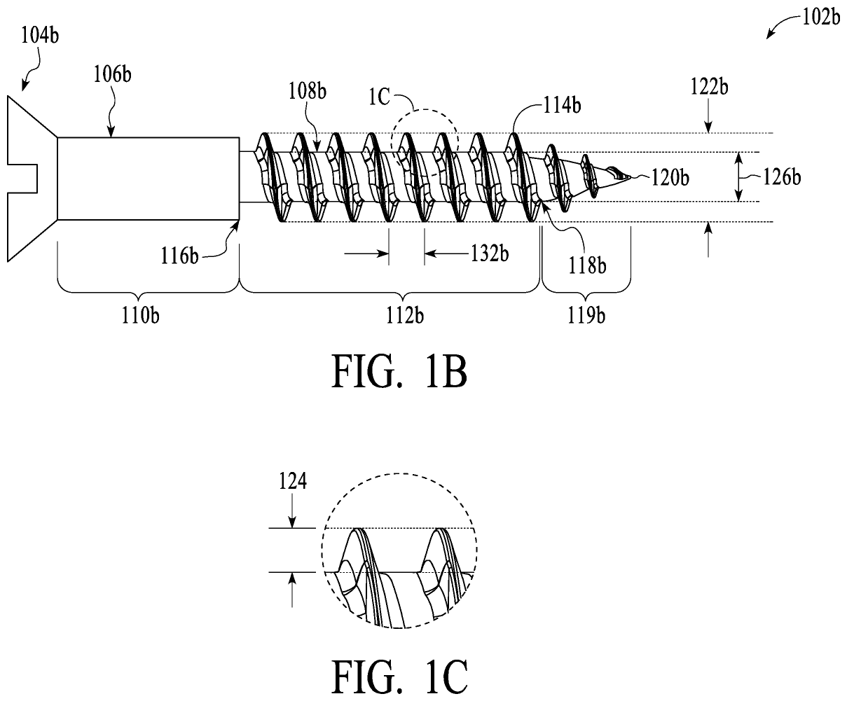

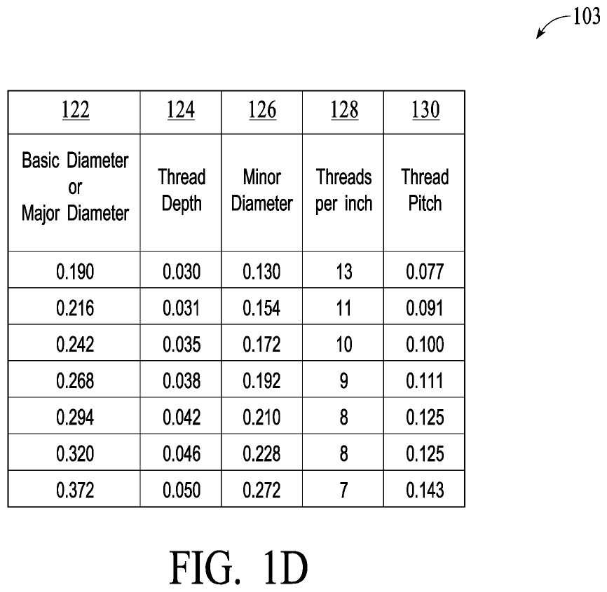

Referring now to FIGS. 1A through 1D, some of the dimensions and tolerances provided in ASME B18.6.1 for a conventional flat head wood screw 102a and flat pan wood screw 102b are shown in table 103 of FIG. 1D; as embodied herein, wood screws 102a and 102b may be defined as having a head 104, a shank 106, a shaft 108, a unthreaded portion 110, a threaded portion 112, a thread 114 extending from a proximal end 116 of threaded portion 112 to a distal end 118 of threaded portion 112. In some embodiments, thread 114 continues within tip portion 119 from distal end 118 to a tip 120.

For the purpose of illustration and the discussion below, those skilled in the art understand that a fastener is commonly defined by a major diameter 122 that is synonymous with basic diameter 122. As shown in table 103, a wood screw 102 with a major diameter 122 equal to 0.372 inch has a thread depth 124 equal to 0.050 inch, and the difference between major diameter 122 and twice the thread depth 124 results in a minor diameter 126 equal to 0.272 inch, where minor diameter 126 may be considered as the diameter of shaft 108. A number of threads 128 and a thread pitch 130 are equal to 7 and 0.143 inch, respectively, where thread pitch 130 is the reciprocal of number of threads 128.

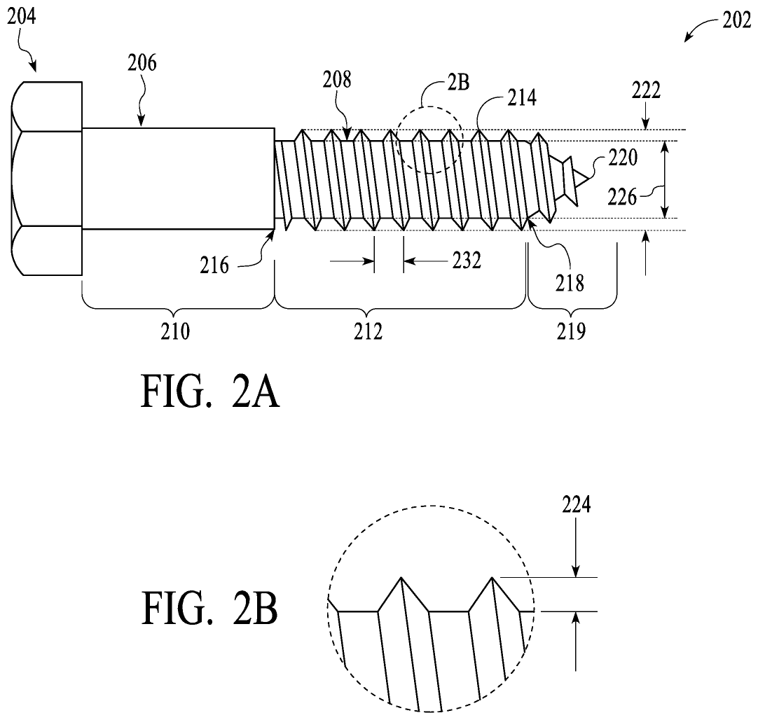

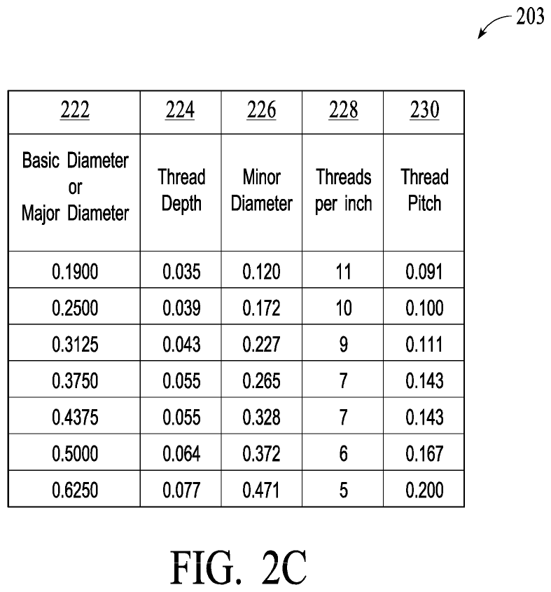

Referring now to FIGS. 2A through 2C, some of the dimensions and tolerances provided in ASME B18.2.1 for a conventional lag screw 202 are shown in table 203 of FIG. 2C; as embodied herein, lag screw 202 may be defined as having a head 204, a shank 206, a shaft 208, an unthreaded portion 210, a threaded portion 212, a thread 214 extending from a proximal end 216 of threaded portion 212 to a distal end 218 of threaded portion 212. In some embodiments, thread 214 continues within tip portion 219 from distal end 218 to a tip 220.

As shown in table 203, a lag screw 202 with a major diameter 222 equal to 0.5000 inch has a thread depth 224 equal to 0.064 inch, where the difference between major diameter 222 and twice the thread depth 224 results in a minor diameter 226 equal to 0.372 inch. A number of threads 228 and a thread pitch 230 are equal to 6 and 0.167 inch, respectively.

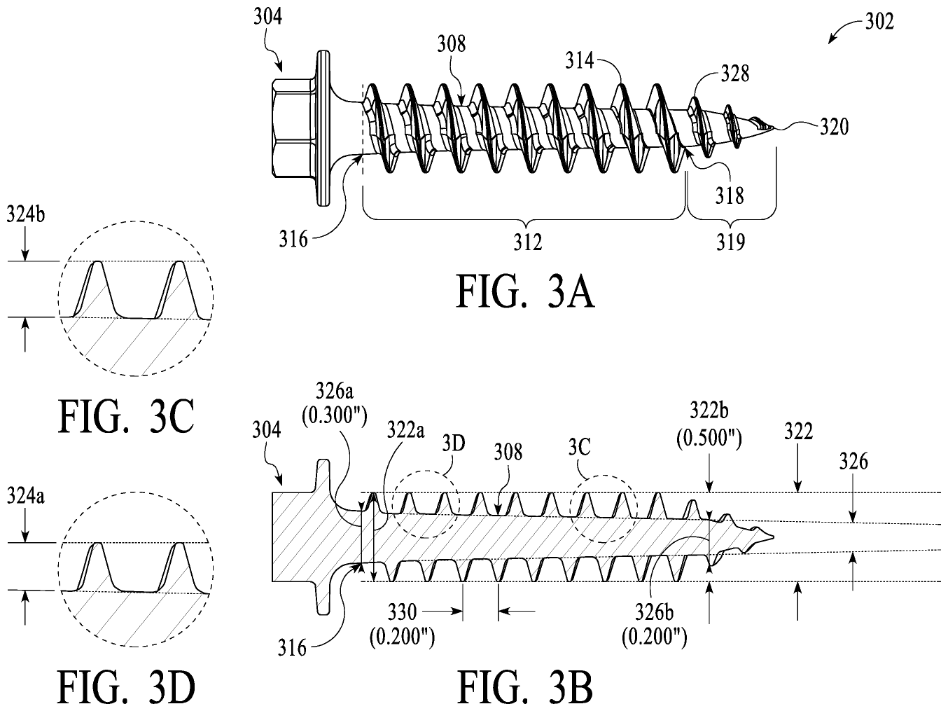

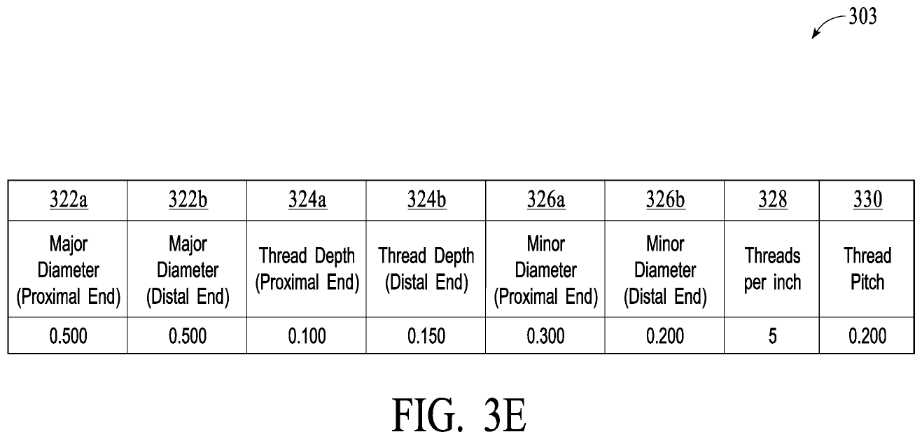

Referring now to FIGS. 3A through 3E, an unconventional, exemplary lag screw 302 that is non-conformal to the standards set forth in ASME B18.6.1 and ASME B18.2.1 is disclosed. The presentation of lag screw 302 is provided for the sole purpose of illustration not an express limitation of the embodiments herein. As stated above, the embodiments disclosed herein apply to a threaded fastener that could be manufactured in accordance with the disclosures presented herein.

Lag screw 302 may be defined as having a head 304, a shaft 308, a threaded portion 312, a thread 314 extending from a proximal end 316 of threaded portion 312 to a distal end 318 of threaded portion 312. In some embodiments, thread 314 continues from distal end 318 to a tip 320. In some embodiments, lag screw 302 may have a shank located between head 304 and proximal end 316. In some embodiments, a feature known to those skilled in the art as a flute may extend away from tip 320 in the direction of threaded potion 312.

It should be noted that, although the disclosed lag screw 302 with be drawn to a hex head, the disclosures herein may be drawn to any head to which use may engage which drive any fastener into the installation surface. Examples of such heads include, but are not limited to, pan heads, button or dome heads, round heads, truss heads, flat heads, oval or raised heads, bugle heads, fillister heads, and flanged heads.

For the purpose of illustration, some of the dimensions of lag screw 302 are shown in table 303. Lag screw 302 has a major diameter 322a equal to 0.5000 at proximal end 316 inch, and a major diameter 322b is also equal to 0.5000 inch at distal end 318b. Thread depth 324a at proximal end 316a is equal to 0.100 inch, where the difference between major diameter 322a and twice the thread depth 324a results in a minor diameter 326a equal to 0.300 inch; similarly, thread depth 324b at distal end 318b is equal to 0.150 inch resulting in a minor diameter 326b equal to 0.200 inch. A number of threads 328 and a thread pitch 330 are equal to 5 and 0.200 inch, respectively.

Smaller minor diameter 326b resulting in a greater thread depth 324b at distal end 318b allows a user to experience a higher withdrawal capacity (i.e., the pullout load that the fastener can withstand) while maintaining an ease of installation such as, for instance, avoiding having to drill a pilot hole when the fastener is being driven into wood. The increase is withdrawal performance facilitates a user of fewer fasteners when, for instance, securing a mount to an installation surface. As a result, installation time is reduced for each mount being secured to an installation surface. The installation of a large system employing numerous surface mounts (e.g., the installation of a solar power system comprising numerous solar panel modules secured to the mounts) gains efficiency.

The unconventional sizes and dimensions of lag screw 302 are distinguishable from the conventional sizes and dimensions of wood screws 102 and lag screws 202. A first distinction may be determined as a function of a variable minor diameter. As discussed above, minor diameter 326 of lag screw 302 varies between proximal and distal ends 316 and 318, respectively, where minor diameter 326a is equal to 0.300 inch at the former and minor diameter 326b is equal to 0.200 inch at the latter; however, minor diameters 126 and 226 for wood screws 102 and lag screws 202, respectively, are constant.

A second distinction may be determined as a function of a variable thread depth. As discussed above, thread depth 324 of lag screw 302 varies between proximal and distal ends 316 and 318, respectively, where thread depth 324a is equal to 0.100 inch at the former and thread depth 324b is equal to 0.150 inch at the latter; however, thread depths 124 and 224 of wood screw 102 and lag screw 202, respectively, are constant.

A third distinction may be determined as a function of a thread depth 324 differences between lag screw 302 and one or more published fasteners, each being identified as having a major diameter 322 equal to or less than major diameter 322a at proximal end 316. With respect to wood screw 102, table 103 indicates that the fastener with major diameter 122 equal to 0.372 inch is the greatest value of major diameters 122 published in table 103, which is less than major diameter 322a equal to 0.500 inch. As discussed above and shown in table 303, thread depth 324a at proximal end 316 of lag screw 302 is equal to 0.100 inch, whereas thread depth 124 of wood screw 102 is equal to 0.050 inch for wood screw 102 with major diameter 122 equal to 0.372 inch. Thread depth 324a is greater than thread depth 124 by a difference of 0.050 inch. As such, it is observed that thread depth 324a at proximal end 316 of lag screw 302 is greater than thread depth 124 of a published fastener identified as having a major diameter less than the major diameter 322a of lag screw 302 at proximal end 316.

With respect to lag screw 202, table 203 indicates that a fastener with major diameter 222 equal to 0.5000 inch which is equal to major diameter 322a. Thread depth 224 of lag screw 202 is equal to 0.064 inch. Because thread depth 324a of lag screw 302 at proximal end 316 equal to 0.100 inch is greater than thread depth 124 by a difference of 0.036 inch, it is observed that thread depth 324a is greater than thread depth 124 of a published fastener identified having a major diameter 222 equal to the major diameter 322a of lag screw 302 at proximal end 316. Additionally, it is observed that thread depth 324a is greater than thread depths 224 of the other published fasteners in table 203 with major diameters 222 equal to 0.1900 inch, 0.2500 inch, 0.3125 inch, 0.3750 inch, and 0.4375 inch having thread depths 224 equal to 0.035 inch, 0.039 inch, 0.043 inch, 0.055 inch, and 0.055 inch, respectively, each of which is less than thread depth 324a equal to 0.100 inch.

Similarly, a fourth distinction may be determined as a function of a thread depth differences between lag screw 302 and one or more published fasteners, each being identified as having a major diameter equal to or less than major diameter 322b of lag screw 302 at distal end 318. With respect to wood screw 102, table 103 indicates that the fastener with major diameter 122 equal to 0.372 inch is the greatest value of major diameters 122 published in table 103, which is less than major diameter 322b equal to 0.500 inch. As discussed above and shown in table 303, thread depth 324b at distal end 316 of lag screw 302 is equal to 0.150 inch, whereas thread depth 124 of wood screw 102 is equal to 0.050 inch for wood screw 102 with major diameter 122 equal to 0.372 inch. Thread depth 324b is greater than thread depth 124 by a difference of 0.100 inch. As such, it is observed that thread depth 324b at distal end 316 of lag screw 302 is greater than thread depth 124 of a published fastener identified as having a major diameter less than the major diameter 322b of lag screw 302 at distal end 316.

With respect to lag screw 202, table 203 indicates that a fastener with major diameter 222 equal to 0.5000 inch which is equal to major diameter 322a. Thread depth 224 of lag screw 202 is equal to 0.064 inch. Because thread depth 324a of lag screw 302 at proximal end 316 equal to 0.100 inch is greater than thread depth 124 by a difference of 0.036 inch, it is observed that thread depth 324a is greater than thread depth 124 of a published fastener identified having a major diameter 222 equal to the major diameter 322a of lag screw 302 at proximal end 316.

A fifth distinction is determined as a function of thread pitch differences between lag screw 302 and one or more published fasteners identified as having a major diameter equal to or less than major diameter 322a at proximal end 316. Thread pitch 130 of wood screw 102 with major diameter of 0.372 inch is equal to 0.143 inch, and thread pitch 230 of lag screw 202 with a major diameter 0.5000 is 0.167 inch; however, thread pitch 330 of lag screw 302 is equal to 0.200 inch which is greater than thread pitches 130 and 220. As such, it is observed that thread pitch 330 is greater than thread pitches 130 and 220 of published fasteners identified having major diameters 122 and 222 less than or equal to, respectively, the major diameter 322a of lag screw 302 at proximal end 316.

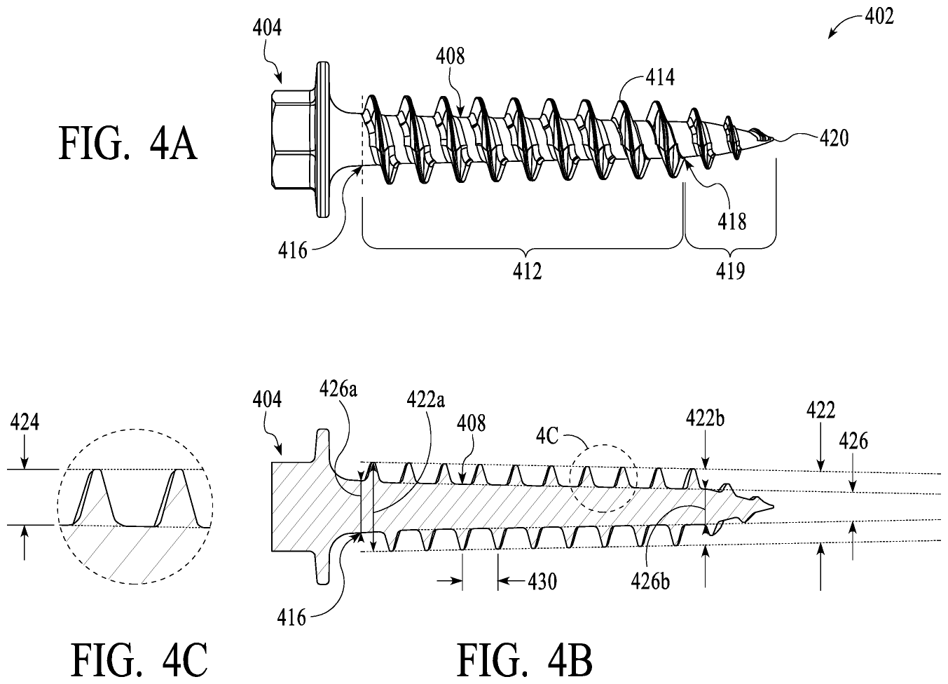

Referring to FIGS. 4A through 4C, lag screw 402 may be defined as having a head 404, a shaft 408, a threaded portion 412, a thread 414 extending from a proximal end 416 of threaded portion 412 to a distal end 418 of threaded portion 412. In some embodiments, thread 414 continues from distal end 418 to a tip 420. In some embodiments, lag screw 402 may have a shank located between head 404 and proximal end 416. In some embodiments, a feature known to those skilled in the art as a flute may extend away from tip 420 in the direction of threaded potion 412.

For the purpose of illustration, lag screw 402 may be the same as lag screw 302 except that major diameter 422 is variable, where major diameter 422 decreases from major diameter 422a at proximal end 416 to major diameter 422b at distal end 418 as thread 414 extends from proximal end 416. In one embodiment, thread depth 424 remains constant between proximal and distal ends 416 and 418, respectively.

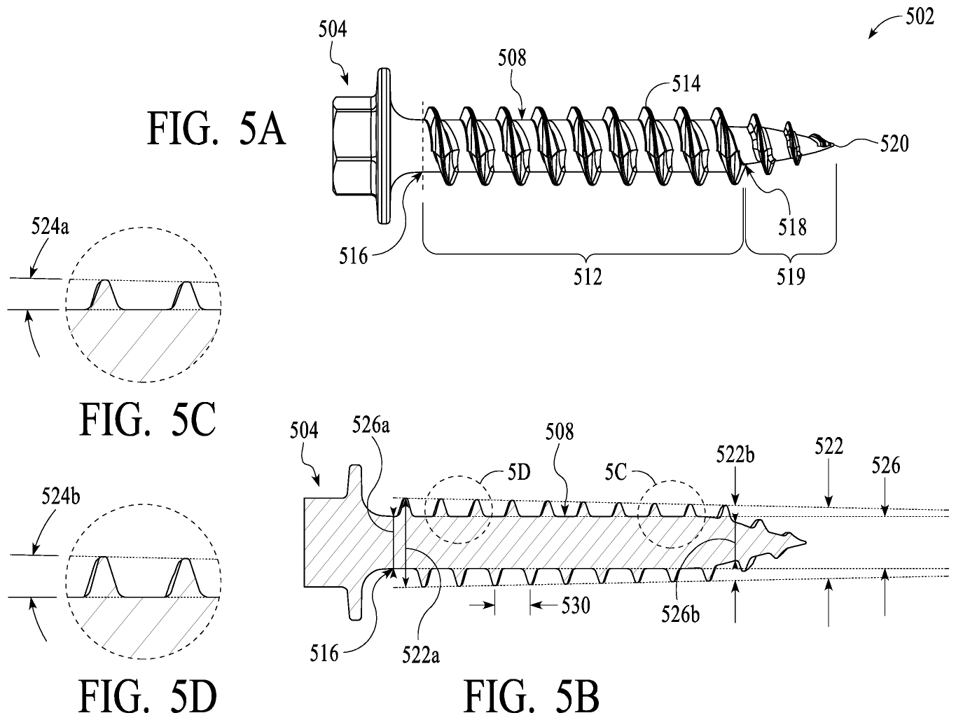

Referring to FIGS. 5A through 5D, lag screw 502 may be defined as having a head 504, a shaft 508, a threaded portion 512, a thread 514 extending from a proximal end 516 of threaded portion 512 to a distal end 518 of threaded portion 512. In some embodiments, thread 514 continues from distal end 518 to a tip 520. In some embodiments, lag screw 502 may have a shank located between head 504 and proximal end 516. In some embodiments, a feature known to those skilled in the art as a flute may extend away from tip 520 in the direction of threaded potion 512.

For the purpose of illustration, lag screw 502 may be the same as lag screw 302 except that major diameter 522 is variable and minor diameter 526 is constant. Because major diameter 522 is variable, thread depth 524a is less than thread depth 524b, indicating a decrease in the depth of thread 524 as it extends from proximal end 516.

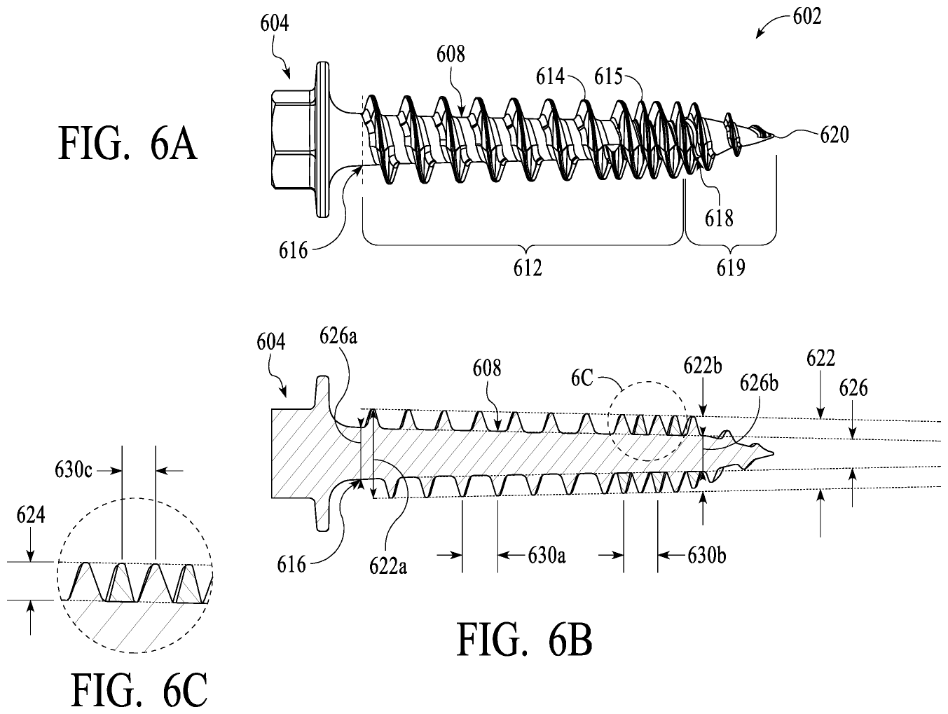

Referring to FIGS. 6A through 6C, lag screw 602 may be defined as having a head 604, a shaft 608, a threaded portion 612, and a first thread 614 extending between from proximal end 616 of threaded portion 610 to a distal end 618 of threaded portion 610. In some embodiments, first thread 614 continues from distal end 618 to a tip 620. As shown, a second thread 615 extends within threaded portion 612 in between first threads 614. In some embodiments, a feature known to those skilled in the art as a flute may extend away from tip 620 in the direction of threaded potion 612.

For the purpose of illustration, lag screw 602 may be the same as lag screw 302 except that major diameter 622 is variable and second thread 615 has been added, and major diameter 622 decreases as thread 614 extends from proximal end 616 along threaded portion 612. Similar to thread pitch 630a, a thread pitch 630b is equal to thread pitch 630a; however, a resulting thread pitch 630c between first and second threads 614 and 615, respectively, is half of both thread pitches 630a and 630b.

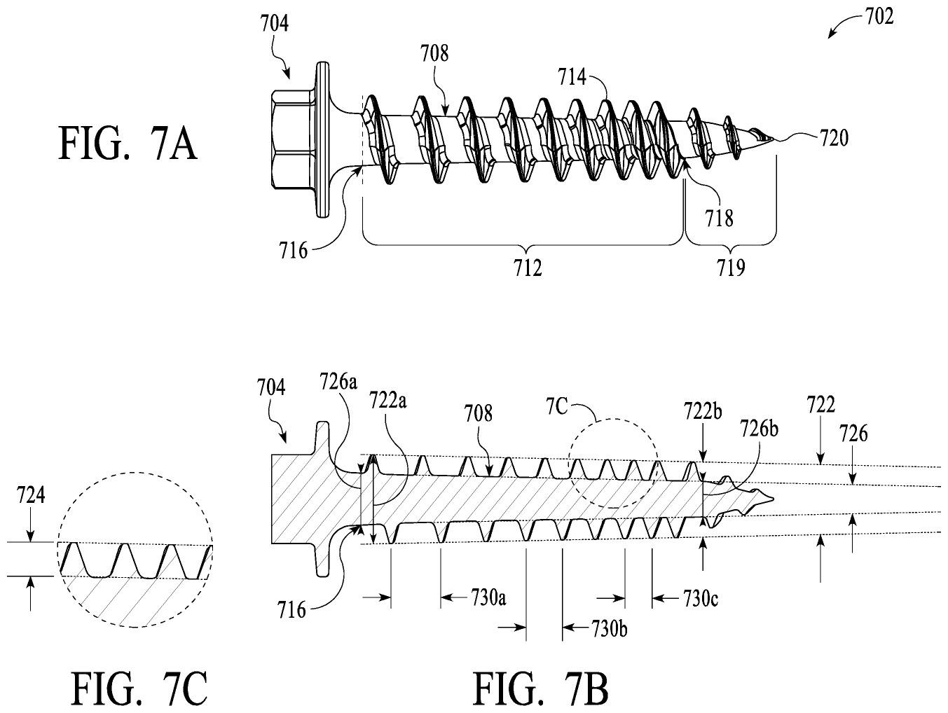

Referring to FIGS. 7A through 7C, lag screw 702 may be defined as having a head 704, a shaft 708, a threaded portion 712, a thread 714 extending from a proximal end 716 of threaded portion 712 to a distal end 718 of threaded portion 712. In some embodiments, thread 714 continues from distal end 718 to a tip 720. In some embodiments, lag screw 702 may have a shank located between head 704 and proximal end 716. In some embodiments, a feature known to those skilled in the art as a flute may extend away from tip 720 in the direction of threaded potion 712.

For the purpose of illustration, lag screw 702 may be the same as lag screw 302 except that maximum diameter 722 and thread pitch 730 are variable, where thread pitch 730a is greater than thread pitch 730b, and thread pitch 730b is greater than thread pitch 730c.

It should be understood that the aspects, features and advantages made apparent from the foregoing are efficiently attained and, since certain changes may be made in the disclosed inventive embodiments without departing from the spirit and scope of the invention, it is intended that all matter contained herein shall be interpreted as illustrative and not in a limiting sense.

What is claimed is:

1. A method for mounting a surface mount to an installation surface, comprising:
positioning a surface mount against or above an installation surface; and
applying a tightening force to at least one fastener extending within an aperture of the surface mount until the surface mount is mounted to the installation surface, where
at least one fastener includes a head, a shaft having a threaded portion, and a thread extending from a proximal end of the threaded portion to at least a distal end of the threaded portion, where
a major diameter of the thread is constant between the proximal and distal ends of the threaded portion.
a minor diameter of the shaft is variable between the proximal and distal ends of the threaded portion, and

2. The method of claim 1, wherein a thread pitch of the thread is variable between the proximal and distal ends of the threaded portion.

3. The method of claim 1, wherein the at least one fastener includes a shank portion between the first head and the proximal end of the threaded portion.

4. The method of claim 1, wherein the thread engages a wooden structure.

5. The method of claim 1, wherein the surface mount is positioned above the installation surface when a tip of at least one fastener extending within an aperture extends beyond a bottom surface of the surface mount prior to the application of the tightening force.

6. The method of claim 1, wherein the surface mount is employed in a solar panel system.

7. A method for mounting a surface mount to an installation surface, comprising:
positioning a surface mount against or above an installation surface; and
applying a tightening force to at least one fastener extending within an aperture of the surface mount until the surface mount is mounted to the installation surface, where
at least one fastener includes a head, a shaft having a threaded portion, and a thread extending from a proximal end of the threaded portion to at least a distal end of the threaded portion, where
a major diameter of the thread is variable between the proximal and distal ends of the threaded portion, and
a minor diameter of the shaft is variable between the proximal and distal ends of the threaded portion.

8. The method of claim 7, wherein a thread pitch of the thread is variable between the proximal and distal ends of the threaded portion.

9. The method of claim 7, wherein a thread depth of the thread is constant between the proximal and distal ends of the threaded portion.

10. The method of claim 7, wherein a thread depth of the thread is variable between the proximal and distal ends of the threaded portion.

11. The method of claim 7, wherein the at least one fastener includes a shank portion between the first head and the proximal end of the threaded portion.

12. The method of claim 7, wherein the thread engages a wooden structure.

13. The method of claim 7, wherein the surface mount is positioned above the installation surface when a tip of at least one fastener extending within an aperture extends beyond a bottom surface of the surface mount prior to the application of the tightening force.

14. The method of claim 7, wherein the surface mount is employed in a solar panel system.

15. A method for mounting a surface mount to an installation surface, comprising:
positioning a surface mount against or above an installation surface; and
applying a tightening force to at least one fastener extending within an aperture of the surface mount until the surface mount is mounted to the installation surface, where
at least one fastener includes a first head, a first shaft with a first threaded portion, and a first thread extending from a proximal end of the first threaded portion to at least a distal end of the first threaded portion,
the first thread is defined with a first major diameter measured at the proximal end of the threaded portion,
the first shaft is defined with a first minor diameter measured at the proximal end of the threaded portion,
a first thread depth is defined as the difference between the first major diameter and the first minor diameter, and
the first thread depth is greater than a second thread depth of each one published fastener of a plurality of published fasteners having a second major diameter less than or equal to the first major diameter, where
each one published fastener includes a second head, a second shaft with the second threaded portion, and a second thread extending from a proximal end of the second threaded portion to at least a distal end of the second threaded portion,
the second thread is defined with a second major diameter,
the second shaft is defined with a second minor diameter, and
the second thread depth is the difference between the second major diameter and the second minor diameter.

16. The method of claim 15, wherein
the first thread is further defined with a third major diameter measured at the distal end of the threaded portion,
the first shaft is further defined with a third minor diameter measured at the distal end of the first threaded portion, and
a third thread depth is defined as the difference between the third major diameter and the third minor diameter.

17. The method of claim 16, wherein the third thread depth is greater than the first thread depth.

18. The method of claim 15, wherein
the first shaft is further defined with a third minor diameter measured at the distal end of the first threaded portion, and
the third minor diameter is less than the first minor diameter.

19. The method of claim 15, wherein a thread pitch of the first thread is variable between the proximal and distal ends of the threaded portion.

20. The method of claim 15, wherein the at least one fastener includes a shank portion between the first head and the proximal end of the threaded portion.

21. The method of claim 15, wherein the first and second threads engage a wooden structure.

22. The method of claim 15, wherein the surface mount is positioned above the installation surface when a tip of at least one fastener extending within an aperture extends beyond a bottom surface of the surface mount prior to the application of the tightening force.

23. The method of claim 15, wherein the surface mount is employed in a solar panel system.

24. A method for mounting a surface mount to an installation surface, comprising:
positioning a surface mount against or above an installation surface; and
applying a tightening force to at least one fastener extending within an aperture of the surface mount until the surface mount is mounted to the installation surface, where
at least one fastener includes a first head, a first shaft with a first threaded portion, and a first thread extending from a proximal end of the first threaded portion to at least a distal end of the first threaded portion,
the first thread is defined with a first major diameter measured at the distal end of the threaded portion,
the first shaft is defined with a first minor diameter measured at the distal end of the threaded portion,
a first thread depth is defined as the difference between the first major diameter and the first minor diameter, and
the first thread depth is greater than a second thread depth of each one published fastener of a plurality of published fasteners having a second major diameter less than or equal to the first major diameter, where
each one published fastener includes a second head, a second shaft with the second threaded portion, and the second thread extending from a proximal end of the second threaded portion to at least a distal end of the second threaded portion,
the second thread is defined with a second major diameter,
the second shaft is defined with a second minor diameter, and
the second thread depth is the difference between the second major diameter and the second minor diameter.

25. The method of claim 24, wherein
the first thread is further defined with a third major diameter measured at the proximal end of the threaded portion,
the first shaft is further defined with a third minor diameter measured at the proximal end of the first threaded portion, and
a third thread depth is defined as the difference between the third major diameter and the third minor diameter.

26. The method of claim 25, wherein the third thread depth is greater than the first thread depth.

27. The method of claim 24, wherein
the first shaft is further defined with a third minor diameter measured at the proximal end of the first threaded portion, and
the third minor diameter is greater than the first minor diameter.

28. The method of claim 24, wherein a thread pitch of the first thread is variable between the proximal and distal ends of the threaded portion.

29. The method of claim 24, wherein the at least one fastener includes a shank portion between the first head and the proximal end of the threaded portion.

30. The method of claim 24, wherein the first and second threads engage a wooden structure.

31. The method of claim 24, wherein the surface mount is positioned above the installation surface when a tip of at least one fastener extending within an aperture extends beyond a bottom surface of the surface mount prior to the application of the tightening force.

32. The method of claim 24, wherein the surface mount is employed in a solar panel system.
